(19) United States
(12) Patent Application Publication
(10) Pub. No.: US 2012/0155095 A1
(43) Pub. Date: Jun. 21, 2012

(54) ROLL-FORMED HEAT SINK FOR A LIGHTING FIXTURE

(75) Inventor: Patrick H. Ryan, JR., Atlanta, GA (US)

(73) Assignee: LED LIGHTING, ENGINEERING & DESIGN, CORP., Atlanta, GA (US)

(21) Appl. No.: 13/328,708

(22) Filed: Dec. 16, 2011

Related U.S. Application Data
(60) Provisional application No. 61/423,665, filed on Dec. 16, 2010.

(51) Int. Cl. F21V 29/00; B21D 53/02; F28F 7/00

(52) U.S. Cl. 362/382; 165/185; 29/890.03

(57) ABSTRACT

A heat sink and a method of manufacturing a heat sink for an LED light fixture. The heat sink is fabricated by roll forming a thin sheet of aluminum into a heat dissipating structure that has at least one surface that reflects light generated by the LEDs.

### CROSS-REFERENCE TO RELATED APPLICATION

This application claims the benefit of co-pending provisional application No. 61/423,665, which was filed Dec. 16, 2010, the disclosure of which is incorporated by reference herein in its entirety.

### FIELD

The present disclosure relates to lighting fixtures, and more particularly to heat sinks for lighting fixtures, such as fluorescent fixtures.

### BACKGROUND

Existing fluorescent light fixtures can be retrofit to use newer, more efficient Light Emitting Diodes (LEDs), rather than having to replace the entire fixture. The typical approach to fluorescent retrofit kits using LEDs is to fabricate the heat sink through an aluminum extrusion process. When heat sinks are fabricated using aluminum extrusion, there is a minimum thickness that the aluminum must be in order for the aluminum to be extruded. When using the extrusion process, it is very difficult to get the aluminum below thirty-one thousandths of an inch thick. Typically heat sinks fabricated using the extrusion process are approximately sixty-two thousandths of an inch thick. Using the extrusion process causes the use of significantly more aluminum than is actually required for effective cooling due to the minimum thickness required in the extrusion process. Accordingly, there is a need for a method of fabricating heat sinks such as those used in light fixtures whereby the heat sinks are fabricated and have a resultant thickness that is substantially less than the typical sixty-two thousandths of an inch. The ability to fabricate heat sinks that are substantially less than thick than that of sixty-two thousandths of an inch will result in substantial cost savings in the manufacturing process. In addition, a heat sink fabricated from extruded aluminum has a matte finish and a surface that is rough, very diffuse, and very low levels of reflectivity. An alternative to the extrusion process for fabricating a heat sink is to fabricate the heat sink out of an aluminum sheet that is bent on a press brake. This approach uses far less material than the extrusion process but is not necessarily less expensive due to the added cost of labor to bend the material. It would be desirable to have a heat sink fabricated through use of a roll formed process, resulting in a reduction of manufacturing costs and an increase in manufacturing efficiency.

### SUMMARY

One aspect of the present disclosure provides a heat sink for an LED light fixture, comprising: a roll formed thin sheet of aluminum formed into a heat dissipating structure, the structure having at least one surface that reflects light generated by the LEDs.

Another aspect of the present disclosure provides an LED light fixture, comprising: a heat sink comprising a roll formed thin sheet of specular aluminum formed into a heat dissipating structure; at least one LED positioned proximate the heat sink; and, an electrical connector for conducting electricity from a power source to the at least one LED.

Another aspect of the present disclosure provides a method of manufacturing a heat sink for an LED light fixture, comprising: providing a sheet of specular aluminum; roll forming an aluminum structure; and, mounting at least one LED to the aluminum structure wherein the aluminum structure suitable for use as a heat sink, and wherein the aluminum structure is able to reflect LED light.

### BRIEF DESCRIPTION OF THE DRAWINGS

The drawings disclose exemplary embodiments in which like reference characters designate the same or similar parts throughout the figures of which:

FIG. 1 is a front cutaway view of an exemplary embodiment of a heat sink with a downwardly aimed LED, showing a light ray emanating from the LED and reflecting downward from the heat sink; and

FIG. 2 is an isometric view illustrating an exemplary embodiment of a heat sink shown aimed upwards.

### DETAILED DESCRIPTION

The present disclosure provides a process for making improved heat sinks that are useful in, for example, light fixtures. In one embodiment, the heat sink may be formed of specular aluminum sheets, which have a mirror-like surface, thereby enabling the heat sink to also serve as a reflector. A heat sink fabricated using a roll form process allows for light to be reflected more efficiently than diffuse aluminum, which scatters reflected light. Specular finished aluminum can reflect as much as 98% of the light incident upon it. This specular surface can be formed into a shape that directs the light rays out of the fixture and into the room. The heat sink of the present disclosure is made using a roll forming process, a high speed, low labor method. Roll forming is used in the construction industry to form gutters, wall studs and roof panels, but is believed to not have heretofore been used with specular aluminum. Heat sinks fabricated from aluminum that has been roll formed can be made much thinner than extruded aluminum, resulting in substantially increased available surface area to act as a heat sink. Furthermore, a press brake typically forms sheets into planar structures while a roll form process can form curved surfaces such as a parabolic profile. Accordingly, the roll formed heat sink of the present disclosure can provide improved efficiency as a heat sink due to the available surface area to absorb and dissipate heat from the fixture.

In addition the roll formed process allows for the creation, in one step, of an alternative embodiment of a colored aluminum heat sink. In this embodiment, aluminum that has been pre-coated with a colored material, such as paint, is roll formed to fabricate a heat sink having any color. It is contemplated that the colored material for coating aluminum may be plastics or other materials capable of withstanding the roll form shaping process. In an embodiment using the extrusion process, to fabricate a colored aluminum heat sink would require an additional step following the extrusion process of applying a colored material to the surface of the heat sink.

The roll forming process allows fabrication of heat sinks of various lengths so the standard 2-foot, 4-foot and even 8-foot long fluorescent tubes can be emulated along with non-standard, custom lengths.

The rolling process is designed so that the heat sink formed thereby also has optical reflective properties and acts as a reflector to direct the light in a downward direction thus increasing the efficacy of the luminaire. In a typical fluorescent fixture, a fairly large portion, perhaps as much as 50% of the light emitted by the fluorescent tubes is trapped in the fixture and does not propagate into the space it is supposed to light.

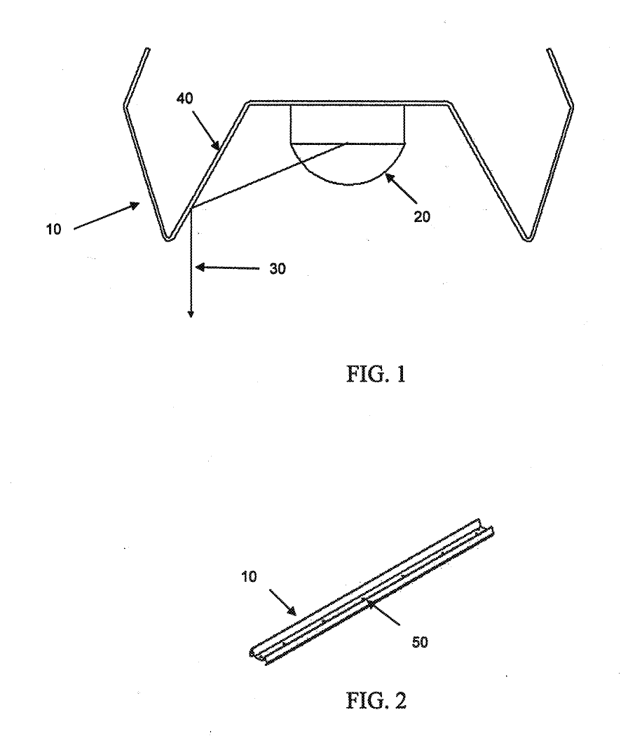

FIG. 1 shows a side cutaway view of a heat sink 10 with an LED 20 mounted thereto. The light ray 30 illustrates how light from the LED reflects off a side wall 40 and is aimed downward toward the surface to be lighted. FIG. 2 shows a perspective view of a heat sink 10 showing holes 50 utilized for mounting the LEDs 20 or for mounting the heat sink to a light fixture (not shown). It is to be understood that roll formed process facilitates the fabrication of a heat sink that may have a number of different cross-sectional shapes, such as the shape illustrated in FIG. 1, parabolic or any other shape.

A method of forming a heat sink with optically reflective properties according to the present disclosure includes providing a long strip of aluminum which is passed through consecutive sets of rolls of continuous bending operation, each step performing only an incremental part of the bend, until the desired cross-section profile is obtained. It is important to pay attention to setting and adjusting roll gaps, apply the right lubricant to prevent pickup of aluminum on the rolls, and use well-designed and finished rolls and good lubricant to prevent surface marks.

In one exemplary embodiment a heat sink formed according to the method of the present disclosure can be used in a light fixture with LEDs to provide 50 foot-candles with 20 watts, as compared to fluorescent fixtures, which provide 25 foot-candles with 40 watts. The heat sink of the present disclosure, therefore, provides improved efficiency of lighting, using less wattage to produce more foot-candles. Furthermore, the very thin thickness of the aluminum exposed to ambient air flow promotes efficient heat dissipation.

The heat sink of the present disclosure can be used or adapted for use in applications or environments other than light fixtures, such as flashlights or other portable lighting devices, heat reflectors, and the like.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

As used in the specification and the appended claims, the singular forms “a,” “an” “the” include plural referents unless the context clearly dictates otherwise.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following inventive concepts.

It should further be noted that any patents, applications and publications referred to herein are incorporated by reference in their entirety.

What is claimed is:

1. A heat sink for an LED light fixture, comprising: a roll formed thin sheet of aluminum formed into a heat dissipating structure, the structure having at least one surface that reflects light generated by the LEDs.

2. The sink of claim 1, wherein the heat sink has a profile having at least one surface that is flat and disposed at an angle to direct light out of the fixture toward an intended direction.

3. The sink of claim 2, wherein the profile has at least one surface that is parabolic.

4. The heat sink of claim 1 wherein the roll formed thin sheet of aluminum is colored.

5. The heat sink of claim 4, wherein the roll formed thin sheet of aluminum is colored by way of painting the thin sheet of aluminum a desired color prior to the thin sheet being manipulated in a roll form process.

6. An LED light fixture, comprising:
a) a heat sink comprising a roll formed thin sheet of specular aluminum formed into a heat dissipating structure;
b) at least one LED positioned proximate the heat sink; and,
c) an electrical connector for conducting electricity from a power source to the at least one LED.

7. The LED light fixture of claim 6, wherein the heat sink wherein at lest one surface of the roll formed thin sheet of aluminum is colored.

8. A method of manufacturing a heat sink for an LED light fixture, comprising:
a) providing a sheet of specular aluminum;
b) roll forming an aluminum structure; and,
c) mounting at least one LED to the aluminum structure
wherein the aluminum structure suitable for use as a heat sink, and
wherein the aluminum structure is able to reflect LED light.

9. The method of claim 8 wherein the sheet of specular aluminum is pre-coated with a colored material.

10. The method of claim 9 wherein the colored material is heat resistant.

11. The method of claim 8 wherein the sheet of aluminum has a thickness substantially less than sixty-two thousandths of an inch.

12. The method of claim 8 wherein the sheet of aluminum has a thickness that is no greater than thirty-one thousandths of an inch.
